(19) United States
(12) Patent Application Publication
(10) Pub. No.: US 2006/0092652 A1
(43) Pub. Date: May 4, 2006

(54) Lighting apparatus

(76) Inventor: Billy Lau, Walnut, CA (US)

Correspondence Address: Billy Lau, 486 Vista Del Norte, Walnut, CA, 91789-1605, US

(21) Appl. No.: 10/981,337

(22) Filed: Nov. 3, 2004

(51) Int. Cl. B60Q 1/26

(52) U.S. Cl. 362/503

(57) ABSTRACT

The present invention relates to a lighting apparatus suitable to be mounted on the window of a vehicle. An embodiment of the present invention comprises a vehicle window mount being suitable for mounting on the edge of a vehicle window and a lighting fixture being disposed on the vehicle window mount in the proximity of the vehicle window when the embodiment is installed on the vehicle window.

### FIELD OF THE INVENTION

This invention generally relates to illumination. Particularly, this invention relates to a lighting apparatus suitable to be mounted on the window of a vehicle.

### SUMMARY OF THE INVENTION

The present invention relates to a lighting apparatus suitable to be mounted on the window of a vehicle. An embodiment of the present invention comprises a vehicle window mount being suitable for mounting on the edge of a vehicle window and a lighting fixture being disposed on the vehicle window mount in the proximity of the vehicle window when the embodiment is installed on the vehicle window.

### DESCRIPTION OF THE DRAWINGS

A better understanding of the invention may be gained from the consideration of the following detailed descriptions taken in conjunction with the accompanying drawings in which:

FIG. 1 shows a simplified sectional view of an embodiment according to the present invention.

FIG. 2 shows a simplified sectional view of an alternative embodiment according to the present invention.

FIG. 3 shows a simplified sectional view of a second alternative embodiment according to the present invention.

FIG. 4 shows a simplified sectional vie w of a third alternative embodiment according to the present invention.

FIG. 5 shows a simplified schematic of the embodiment shown in FIG. 1.

### DETAILED DESCRIPTION OF THE INVENTION

In the description that follows, like parts are indicated throughout the specification and drawings with the same reference numerals. The present invention is not limited to the specific embodiments illustrated herein.

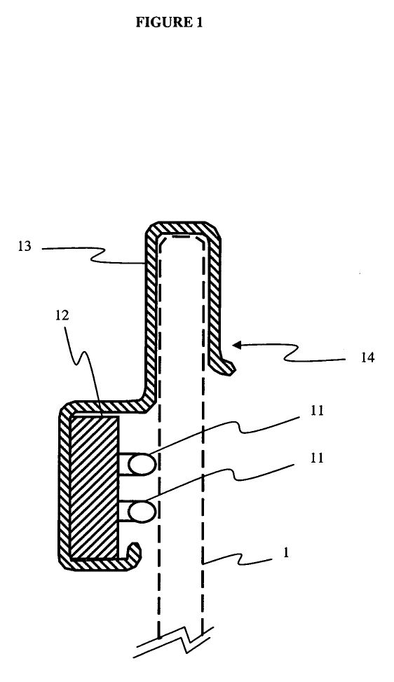

FIG. 1 shows a simplified sectional view of an embodiment according to the present invention. Referring to FIG. 1, on base 12 is a light emitting diode array 11. Light emitting diode array 11 is a light source and base 12 is a lighting fixture. Although FIG. 1 shows that light emitting diode array 11 is on one side of base 12, light emitting diode array 11 may be on both sides of base 12. Base 12 attaches to a folded wire loop 13, which functions as a vehicle window mount. Base 12 attaches to a vehicle window 1 through folded wire loop 13. Folded wire loop 13 may be made from a resilient material and formed in a manner so that it may clamp to vehicle window 1 when the embodiment is installed on vehicle window 1. Vehicle widow 1 is not a part of the present invention and it is shown with dash lines in the figures. Folded wire loop 13 will clamp to vehicle window 1 if the distance between the two wires in a section of folded wire loop 13, for example at position 14 indicated in FIG. 1, is less than the thickness of vehicle window 1. Further, appropriately shaped and sized wire loop 13 will allow vehicle window 1 to close properly. Numerous design variations are possible for folded wire loop 13. An example of design variation for folded wire loop 13 is in U.S. Pat. No. 4,002,138 to Dobala, which is incorporated by reference herein. Optionally, the embodiment has a second folded wire loop that attaches to base 12 for mounting base 12 onto vehicle window 1. FIG. 1 shows that the lighting fixture, which includes base 12, and the light emitting diode array 11 light source is in the proximity of vehicle windows 1 when the embodiment is installed on vehicle windows 1.

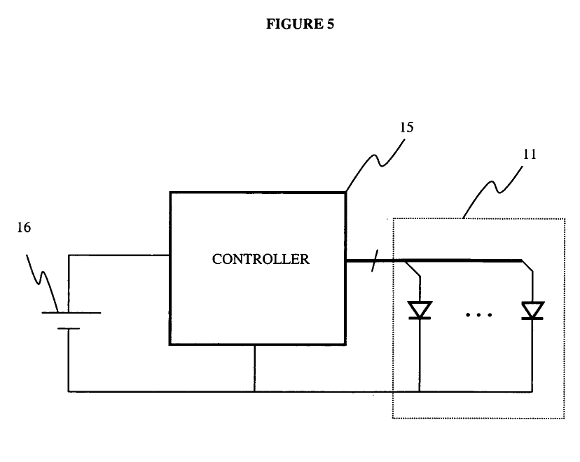

Light emitting diode array 11 comprises multiple light emitting diodes of at least one color. A controller 15, not shown in FIG. 1, which has at least two drive channels, drives light emitting diode array 11. Each drive channel drives at least one light emitting diode in light emitting diode array 11. A representative simplified schematic diagram of the embodiment is shown in FIG. 5. One skilled in the art readily understands the controller electronic circuit design and the circuit connection to the light emitting diodes in light emitting diode array 11. Therefore, an explanation is not necessary to enable one skilled in the art to implement the controller. Inside controller 15, there may be a power switch or a sensor for controlling power flow to light emitting diode array 11. Controller 15 is a part of a power supply in the embodiment. A power supply may include, for example, a battery holder. Power source battery 16 in the battery holder, however, is not a part of the power supply. Controller 15 controls the lighting pattern and the changing of lighting pattern by controlling the power flowing to the light emitting diodes in light emitting diode array 11. Controller 15 and the integrated circuit for implementing controller 15 are commercially available. Many of the integrated circuits that are suitable for use in controller 15 are off-the-shelf components specifically designed for lighting control. Integrated circuits that are designed specifically for controlling an emitting diode array to display text or messages or symbols are readily available commercially.

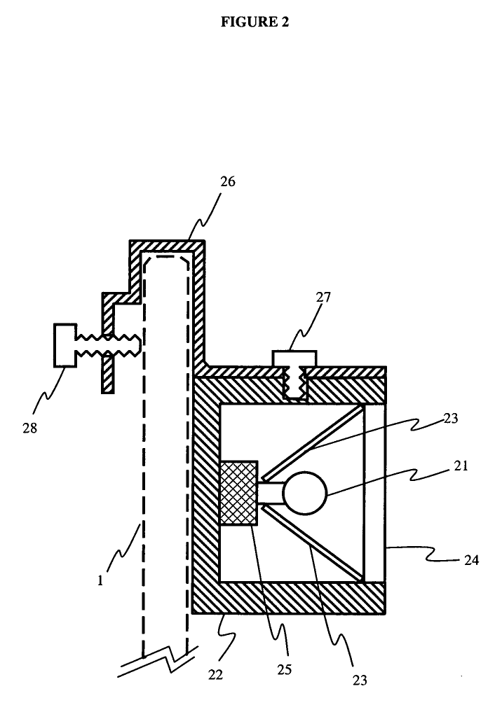

FIG. 2 shows a simplified sectional view of an alternative embodiment according to the present invention. Referring to FIG. 2, a light source, which includes an incandescent light bulb 21, is in a lighting fixture. The lighting fixture comprises a housing 22, a reflector 23, a faceplate 24, and a socket 25 on which incandescent light bulb 21 is mounted. Faceplate 24 is light-transmissive. It may be made from a light-transmissive material or has holes to allow light to pass through. The lighting fixture attaches to a bracket 26 through at least one screw 27. The screw hole on bracket 26 is shaped and sized to allow for mechanical alignment between bracket 26 and the lighting fixture. Bracket 26 functions as a vehicle window mount. A setscrew 28 on bracket 26 is for locking bracket 26 onto to vehicle window 1. Set screw 28 is suitable for hand tightening. A power supply, which is not shown in the figure, powers incandescent light bulb 21 directly without going though any controller. An optional power switch in the power supply controls the power flow to incandescent light bulb 21. In operation, when power is applied to this embodiment and the optional power switch is on, incandescent light bulb 21 is on. On faceplate 24, there may be messages or graphics. Alternatively, other light sources such as, for example, a florescent lamp or a light emitting diode, may be used in place of incandescent light bulb 21, socket 25, and reflector 23. Faceplate 24 may include an electrically controlled display such as, for example, a liquid crystal display. The message or graphics on faceplate 24 may have, for example, entertainment or decorative uses. The power supply may be located away from incandescent light bulb 21.

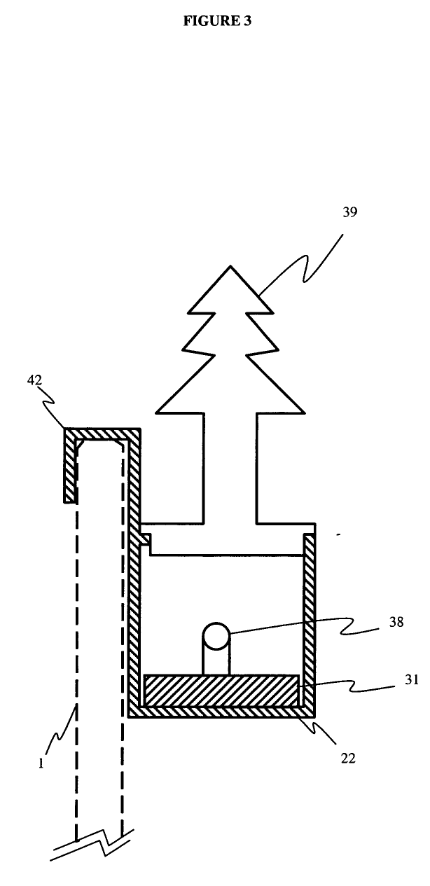

FIG. 3 shows a simplified sectional view of a second alternative embodiment according to the present invention. Referring to FIG. 3, a light source that comprises a ultra-violet light emitting diode 38 is disposed in housing 22. A power supply including a battery holder is disposed in battery compartment 31. A generally U-shaped bracket 42 for receiving a vehicle window 1 extends from housing 22. FIG. 3 shows that bracket 42 is complementary to vehicle window 1. In the fabrication of this embodiment, bracket 42 and housing 22 may be made from a moldable material such as, for example, plastic or rubber. A light-transmissive florescent decorative member 39 extends from housing 22. A representative light emitting diode such as ultra-violet light emitting diode 38 requires a power supply that includes a power-limiting device such as, for example, a controller or a current limiting series resistor to operate properly. The power supply is located in housing 22. Methods and devices for powering a light emitting diode are well understood by one skilled in the art and do not require an explanation. FIG. 3 also shows that the lighting fixture, which includes housing 22 and decorative member 39, and the ultra-violet light emitting diode 38 light source is in the proximity of vehicle windows 1 when the embodiment is installed on vehicle windows 1.

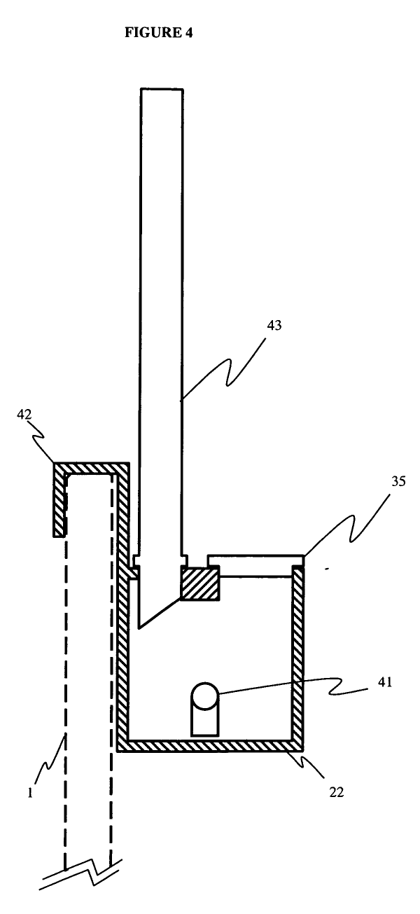

FIG. 4 shows a simplified sectional view of a third alternative embodiment according to the present invention. Referring to FIG. 4, a light source that comprises an array of color light emitting diodes 41 is disposed in the lighting fixture, which includes housing 22 and lighting fixture window 35. A generally U-shaped bracket 42 for receiving a vehicle window 1 extends from housing 22. In the fabrication of this embodiment, bracket 42 and housing 22 may be made from a moldable material such as, for example, plastic or rubber, and they may be molded as a single piece as shown in the figure. A post 43 extends from housing 22. A representative array of color light emitting diode 41 requires a power supply that includes a controller that provides time changing color lighting sequences. Methods and devices for powering and controlling a light emitting diode are well understood by one skilled in the art and do not require an explanation.

There are numerous variations to the embodiments discussed above which will be trivial to the one skilled in the art. Examples of these variations include but not limited to:
The controller allows at least one mode of operation when power is applied to the embodiment;
The controller controls light sequencing;
The controller controls light intensity;
The lighting fixture is pivotally mounted on the vehicle window mount; pivotal mount are commonly found on commercially available lighting fixture;
The lighting fixture is mounted on the vehicle window mount through a semi-rigid flexible member, a commonly used element in the semi-rigid flexible member for providing the semi-rigidity and the flexibility is a heavy gauge copper wire, lighting fixture mounted on a semi-rigid flexible member are commercially available;
Vehicle window mount is designed for mounting on a the edge on vehicle window such that the vehicle window can be close properly;
Many type of light source, including for examples of light source types include: light emitting diode, incandescent lamps, florescent lamps, black (ultra violet) light lamps, electro luminescent lights, discharge lamps, plasma lamp, strobe light, laser diode, laser, and arc lamps, can be used on the embodiments;
Employing at least two light sources;
Employing at least two types of light sources;
Employing a controller for the light sources;
The controller includes a motion sensor and the embodiment is responsive to motion, for example, the controller may supply power to the light source to turn on the light source when it detects motion and it shuts down power to the light source to turn off the light source after a predetermined time period unless it detects motion, controllers with this function are commercially available;
The controller includes an ambient light sensor and the embodiment is responsive to ambient light, for example, the controller may turn off the light source when the ambient light exceeds a predetermined level, controllers with this function are commercially available;
The controller includes a noise sensor and the light source is responsive to noise; for example, the controller may vary the color or the intensity of the light emitted from the light source according to ambient noise, controllers with this function are commercially available;
The controller has an external signal input and the light source is responsive to external signal; for example, the controller may vary the color or the intensity of the light emitted from the light source according to an external signal, controllers with this function are commercially available;
The light from the lighting fixture is directed; lens, reflector, and shades are commonly employed to direct light;
The embodiment may include an actuator, for example a motor, to move the light source in predetermined motion patterns;
The embodiment may include an actuator, for example a motor, to move a reflector for reflecting the light for the light source in predetermined motion patterns;
Post 43 is made from a light-transmissive material, which may be for example, transparent or translucent, and light form the light source transmits through post 43;
Post 43 is mounted on housing 22;
Post 43 is mounted on bracket 42;
A least a portion of post 43 has florescent dyes and the dye may be on the surface or in the bulk of post 43;
Array of light emitting diode 41 may be replaced by ultra-violet light emitting diodes or a single light emitting diode;
Two or more elements in an embodiment are fabricated as a single piece part;
An element of an embodiment as fabricated in multiple pieces;
A banner is mounted on post 43;
The banner has florescent dye;
A flag is mounted on post 43;
The light source draws power from a dedicated power source, such as for a example, a dedicated battery or a battery in the embodiment;
The power supply may include, for example, a power source, a controller, a switch, a sensor; and
A combination of the above.

Although the embodiment of the invention has been illustrated and that the form has been described, it is readily apparent to those skilled in the art that various modifications may be made therein without departing from the spirit of the invention.

What is claimed is:

1. A lighting apparatus, comprising:
a vehicle window mount suitable for mounting on the edge of a vehicle window;
a lighting fixture being disposed permanently on said vehicle window mount; and
a power supply on said vehicle window mount being disposed to supply power from a power source to said lighting fixture.

2. The lighting apparatus as claimed in claim 1, wherein, said lighting fixture is in the proximity of said vehicle window when said vehicle window mount is mounted on said vehicle window.

3. The lighting apparatus as claimed in claim 1, wherein, said power supply is in said lighting fixture.

4. The lighting apparatus as claimed in claim 1 further comprises a light source.

5. The lighting apparatus as claimed in claim 1, wherein, said power supply further comprises a controller.

6. The lighting apparatus as claimed in claim 5, wherein, said controller controls the electrical power flow in said lighting fixture.

7. The lighting apparatus as claimed in claim 6 further comprises at least one light source, wherein, said power supply further comprises a controller controlling the electrical power flow to said light source.

8. The lighting apparatus as claimed in claim 7, wherein, said controller is responsive to at least one signal.

9. The lighting apparatus as claimed in claim 8, wherein, said controller further comprises at least one sensor and said controller is responsive to the signal from said sensor.

10. The lighting apparatus as claimed in claim 9, wherein, said sensor comprises a motion sensor and said controller turns on at least one of said lighting sources in response to the motion detected by said motion sensor.

11. The lighting apparatus as claimed in claim 10, wherein, said controller further comprises a light sensor and said controller turns off at least one of said light sources in response to the light level detected by said light sensor.

12. The lighting apparatus as claimed in claim 7, wherein, said light source comprises at least one light emitting diode and said controller controls the electrical power flow to said light emitting diode.

13. The lighting apparatus as claimed in claim 12, wherein, said light emitting diode emits ultra violet light.

14. The lighting apparatus as claimed in claim 7 further comprises a decorative member being mechanically supported by said vehicle window mount.

15. The lighting apparatus as claimed in claim 14, wherein, said vehicle window mount mechanically supports said decorative member through said lighting fixture.

16. The lighting apparatus as claimed in claim 15, wherein, said decorative member comprises a post.

17. The lighting apparatus as claimed in claim 16, wherein, said post comprises a flagpole.

18. The lighting apparatus as claimed in claim 17 further comprises a flag on said flagpole.

19. A lighting apparatus, comprising:
a vehicle window mount suitable for mounting on the edge of a vehicle window; and
a lighting fixture being disposed permanently on said vehicle window mount in the proximity of said vehicle window when said vehicle window mount is installed on said vehicle window.

20. The lighting apparatus as claimed in claim 19 further comprises a light source, wherein, said light source is in the proximity of said vehicle window when said vehicle window mount is mounted on said vehicle window.

21. The lighting apparatus as claimed in claim 20, wherein, said light source comprises at least one light emitting diode.

22. The lighting apparatus as claimed in claim 20 further comprises a decorative member being mechanically supported by said vehicle window mount.

23. The lighting apparatus as claimed in claim 22, wherein, said decorative member comprises a post.

24. The lighting apparatus as claimed in claim 23, wherein, said post comprises a flagpole.

25. The lighting apparatus as claimed in claim 24 further comprises a flag on said flagpole.

26. The lighting apparatus as claimed in claim 22 furthered comprises a controller controlling the power flow to said light source.

27. The lighting apparatus as claimed in claim 26, wherein, said controller further comprises at least one sensor and said controller is responsive to the signal from said sensor.

28. The lighting apparatus as claimed in claim 27, wherein, said sensor comprises a motion sensor and said controller changes the electrical power flow in said lighting fixture in response to the motion detected by said motion sensor.

29. A lighting apparatus, comprising:
a vehicle window mount suitable for mounting on the edge of a vehicle window;
a light source; and
a housing for said light source being disposed permanently on said vehicle window mount in the proximity of said vehicle window when said vehicle window mount is mounted on said vehicle window.

30. The lighting apparatus as claimed in claim 29 further comprises a controller controlling the electrical power flow to said light source.

31. The lighting apparatus as claimed in claim 30 further comprises a flagpole being mechanically supported by said vehicle window mount.

32. The lighting apparatus as claimed in claim 31 further comprises a flag on said flagpole.

33. The lighting apparatus as claimed in claim 32 wherein said vehicle window mount mechanically supports said flagpole through said housing and light source illuminates said flagpole.

34. The lighting apparatus as claimed in claim 32, wherein, said controller further comprises at least one sensor and said controller is responsive to the signal from said sensor.
